(19) United States
(12) Patent Application Publication
(10) Pub. No.: US 2024/0398156 A1
(43) Pub. Date: Dec. 5, 2024

(54) BEVERAGE PREPARATION WITH A STABLE OUTLET VALVE

(71) Applicant: SOCIETE DES PRODUITS NESTLE S.A., Vevey (CH)

(72) Inventors: MARCEL FANKHAUSER, Toffen (CH); GILLES GAVILLET, Ursy (CH); MIGUEL GORTCHACOW, Lausanne (CH); STEFAN STALDER, Zollikofen (CH)

(21) Appl. No.: 18/721,959

(22) PCT Filed: Dec. 21, 2022
(86) PCT No.: PCT/EP2022/087145

§ 371 Date: Jun. 20, 2024

(30) Foreign Application Priority Data
Dec. 22, 2021 (EP) 21216970.0

(51) Int. Cl. A47J 31/46; A47J 31/36

(52) U.S. Cl. CPC A47J 31/461; A47J 31/3633

(57) ABSTRACT

A machine (1) is provided for preparing a beverage (4) from a flavouring ingredient (5a) in a processing cavity (5) by mixing the ingredient (5a) with water (4′) and centrifugally driving such ingredient (5a) and the water (4′) about a processing axis (30′). The machine (1) has a valve (30,30a) associated with a beverage passage (26) for controlling the flow and/or the pressure of the beverage (4) along the beverage passage (26). The valve (30,30a) has a valve frame (300,300a) and, relatively movable thereto, a valve part (31,310,311,31a) that extends substantially annularly (31′,31a′) around the processing axis (30′) and/or substantially radially (31″) relative to the processing axis (30′). The valve part (31,310,311,31a) controls a beverage flow and/or beverage pressure along the beverage passage (26).

### FIELD OF THE INVENTION

The field of the invention pertains to beverage preparation machines by centrifuging capsules containing an ingredient of the beverage to be prepared.

For the purpose of the present description, a “beverage” is meant to include any human-consumable liquid substance, such as tea, coffee, hot or cold chocolate, milk, soup, baby food, etc. . . . A “capsule” is meant to include any container such as a packaging for containing a pre-portioned beverage ingredient, e.g. a flavouring ingredient, the packaging forming an enclosure of any material, in particular an airtight or pervious material, porous or non-porous material, e.g. plastic, aluminium, recyclable and/or biodegradable packagings, and of any shape and structure, including soft pods or rigid cartridges for containing the ingredient.

### BACKGROUND ART

Certain beverage preparation machines use capsules containing ingredients to be extracted or to be dissolved and/or ingredients are that stored and dosed automatically in the machine or else are added at the time of preparation of the drink. Some beverage machines possess filling means that include a pump for liquid, usually water, which pumps the liquid from a source of water that is cold or indeed heated through heating means, e.g. a thermoblock or the like.

Especially in the field of coffee preparation, machines have been widely developed in which a capsule containing beverage ingredients is inserted in a brewing device. The brewing device is tightly closed about the capsule, water is injected at the first face of the capsule, the beverage is produced in the closed volume of the capsule and a brewed beverage can be drained from a second face of the capsule and collected into a receptacle such as a cup or glass.

Brewing devices have been developed to facilitate insertion of a “fresh” capsule and removal of the capsule upon use. Examples of such brewing devices are disclosed in EP 1 767 129, WO 2009/043630, WO 2005/004683 and WO 2007/135136. The preparation of a beverage by using centrifugation is also known. Examples of centrifugation processes and corresponding devices are disclosed in WO 2008/148601, WO2008/148650, U.S. Pat. No. 5,566,605, WO 2013/007776, WO 2013/007779 and WO 2013/007780.

Irrespectively of the extraction process itself it has also been proposed to facilitate the handling of capsules by systems for extracting them, in particular by motorizing the opening and/or closure of the extraction system for inserting and/or removing a capsule. Examples of such systems are for example disclosed in EP 1 767 129, WO 2009/113035, WO 2012/025258, WO 2012/025259, WO 2012/041605, WO 2013/127476, WO 2014/096122, WO 2014/096123 and EP2015185946.9.

The preparation of a beverage by using centrifugation is also known. Such beverage preparation includes: providing a beverage (flavoring) ingredient, e.g. as powder and/or leaves, in a capsule; circulating liquid into the capsule and rotating the capsule at sufficient speed to ensure interaction of the liquid with the ingredient while creating a gradient of pressure of liquid in the capsule. Such pressure increases gradually from the centre towards the periphery of the capsule. As liquid traverses the ingredient, e.g. coffee bed, extraction of the ingredient, e.g. coffee compounds, takes place and a liquid extract is obtained that flows out at the periphery of the capsule. Examples of such systems are disclosed in WO 2008/148601, WO 2013/007776, WO 2013/007779, wo 2013/007780, WO 2017/046294, WO 2017/068134 and WO 2017/202746. WO 2021/122502 discloses a centrifugal beverage machine with a rotatable valve arrangement for controlling a flow of water towards a centrifugal beverage mixing chamber.

It has been proposed to prepare beverages by centrifugation along a horizontal axis.

WO 2015/173123 and WO 2015/173124 disclose a centrifugal brewing chamber formed between two enclosing parts that are relatively translatable between an open position and a closed position. The enclosing parts cooperate with a pair of jaws that are movable between a capsule holding position to hold a capsule between the enclosing parts in the open position and a capsule release position to release the capsule. The jaws are actuated by a first actuator and a second actuator that are activated by the enclosing parts during their the relative translation. The jaws guide a capsule into a position between the enclosing parts in the open position and immobilize the capsule thereinbetween. Then, when the enclosing parts are translated together to enclose the capsule, the jaws release the capsule so that the brewing chamber is formed about the capsule. The enclosing parts are rotated about a horizontal axis to centrifuge the capsule for preparing the beverage with the ingredient in the capsule. At the end of beverage preparation, centrifugation stops and the enclosing parts are relatively translated to the open position whereby the used capsule is allowed to drop from the enclosing parts. Then the jaws are brought back into their capsule holding position.

WO 2008/148646 and WO 2008/148650 describe a beverage preparation device wherein a flow restriction is created downstream of the receptacle, in particular a capsule, for example, by a valve which opens or enlarges under the pressure created by the centrifuged liquid leaving the receptacle. The higher the rotational speed, the more the valve opens or enlarges. The valve can be formed by a mobile restriction part of the device which is elastically urged against a rim portion of the capsule. In WO 2017/068134 the centrifugal brewing chamber is fitted with an outlet valve that can be controlled by an inertia body of the machine rotating with the centrifugal brewing chamber. The valve leads into a collector forming a crema chamber in which the beverage upon undergoing a pressure drop at the valve is refined for dispensing into a user-recipient, e.g. a cup or a mug. Such collection chamber is typically arranged around the centrifugal brewing chamber, as for example disclosed in WO 2020/201469.

### SUMMARY OF THE INVENTION

The invention relates to a machine for preparing a beverage from at least one ingredient. Normally such beverage is then dispensed to a user, e.g. to a user-cup or user-mug.

For instance, the machine is a coffee, tea, chocolate, cacao, milk or soup preparation machine. For example, the machine is arranged for preparing within a beverage processing module that includes an ingredient holder, a beverage by passing hot or cold water or another liquid through the ingredient held in the holder, such as a flavouring ingredient, of the beverage to be prepared, such as ground coffee or tea or chocolate or cacao or milk powder.

Such beverage preparation typically includes the mixing of a plurality of beverage ingredients, e.g. water and milk powder, and/or the infusion of a beverage ingredient, such as an infusion of ground coffee or tea with water. One or more of such ingredients may be supplied in loose and/or agglomerate powder form and/or in liquid form, in particular in a concentrate form. A carrier or diluent liquid, e.g. water, may be mixed with such ingredient to form the beverage. Typically, a predetermined amount of beverage is formed and dispensed on user-request, which corresponds to a portion (e.g. a serving). The volume of such a serving may be in the range of 15 to 1000 ml such as 25 to 600 ml for instance 40 to 250 ml, e.g. the volume for filling a cup or mug, depending on the type of beverage. Formed and dispensed beverages may be selected from ristrettos, espressos, lungos, cappuccinos, café latte, americano coffees, teas, etc. . . . For example, a coffee machine may be configured for dispensing espressos, e.g. an adjustable volume of 20 to 60 ml per serving, and/or for dispensing lungos, e.g. a volume in the range of 70 to 200 ml per serving, and/or for dispensing americanos, e.g. a volume in the range of 150 to 750 ml.

An aspect of the invention relates to a machine for preparing a beverage from a flavouring ingredient in a processing cavity. Such a cavity may be configured for holding the ingredient supplied within a capsule. The beverage is prepared by mixing the ingredient with water and centrifugally driving such ingredient and water about a processing axis.

The centrifugation process for preparing a beverage is known for example from EP 2 000 062, EP 2 155 020, EP 2 152 128, WO 2008/148646, WO 2009/106175, WO 2009/106589, WO 2010/026045, WO 2010/026053, WO 2010/066736, WO 2008/148650, WO 2008/148834, WO 2010/066705, WO 2010/063644, WO 2011/023711, WO 2014/096122 or WO 2014/096123.

During beverage preparation, the processing axis may extend horizontally or at an angle thereto. Such angle may be less than 45 deg., for instance less than 30 dege.g. than 15 deg.

Typically, the machine includes one or more of the following components:
a) a fluid system in fluid communication with the flavouring ingredient during beverage preparation;
b) a thermal conditioner, such as in-line heater and/or cooler, for thermally conditioning a flow of liquid circulated to the flavouring ingredient or a batch thermal conditioner for circulating thermally conditioned liquid from the batch conditioner to the flavouring ingredient;
c) a liquid driver, such as a pump, for driving liquid to the flavouring ingredient, in particular a low pressure pump e.g. within the range of 1 to 5 bar, such as 1.5 to 3 bar;
d) a motor for driving the flavouring ingredient in rotation during beverage preparation;
e) an electric control unit, in particular comprising a printed circuit board (PCB), for receiving instructions from a user via an input user-interface and for controlling the thermal conditioner, liquid driver and motor(s); and
f) one or more sensors for sensing at least one characteristic selected from characteristics of fluid system, the thermal conditioner, the liquid driver, a liquid tank, an ingredient collector, a flow of the liquid (e.g. by a flowmeter), a pressure of the liquid and a temperature of the liquid, and for communicating such characteristic(s) to the control unit.

The abovementioned capsule may have a body containing the ingredient and a peripherally projecting flange, e.g. a body in the shape of a cup and a lid covering the mouth of the cup and extending beyond the mouth to form the peripherally projecting flange.

The capsule may have a body that is symmetric or asymmetric, conical or frusto-conical or cylindrical or spherical or hemispherical or frusto-spherical, containing the ingredient, e.g. ground coffee, tea or cacao or another beverage ingredient.

The capsule may be of the type described above under the header “field of the invention”. The capsule may be a capsule that has a container-body, e.g. a generally cup-shaped or hemispherical or hemi-ellipsoidal body, having a flange to which a cover lid (or membrane) is attached, in particular sealed. Typically the capsule contains a beverage ingredient. Examples of suitable capsules are disclosed in WO 2008/148601, WO 2008/148604, WO 2008/148646, WO 2008/148650, WO 2008/148656, WO 2008/148834, WO 2011/141532, WO 2011/141535, WO 2013/072239, WO 2013/072297, WO 2013/072326, WO 2015/044400. The capsule may be of the variety commercialised by Nespresso under the brand Vertuo.

The machine has a rotatable ingredient handling system for holding and rotating about the processing axis the flavouring ingredient, e.g. contained within the abovementioned capsule, and water during centrifugation. The ingredient handling system has at least one beverage outlet and at least one water inlet for supplying the water to the flavouring ingredient.

The handling system may include a first ingredient handler and a second ingredient handler that are movable one relative to the other from:
an ingredient transfer configuration for receiving the flavouring ingredient by the first and second capsule handlers and/or releasing such ingredient from the first and second ingredient handlers; to
an ingredient processing configuration for centrifuging the flavouring ingredient and the water by rotation about the processing axis; and
vice versa.

Upon processing, the ingredient, e.g. contained in a capsule, may be collected in an ingredient (or ingredient capsule) collector downstream the handling system, as for example disclosed in WO 2009/074559 or WO 2009/135869.

The machine incorporates a beverage passage, e.g. a beverage fluid communication with the conduit, in beverage outlet. The passage is configured to guide the beverage from the outlet towards a beverage dispensing outlet.

The machine includes a valve associated with the beverage passage, such as a centrifugal and/or electric valve, for controlling the flow and/or the pressure of the beverage along the beverage passage. The valve is configured to increase and reduce, such as allow and interrupt, a beverage flow and/or beverage pressure at a valve portion of the passage.

The machine has a machine frame and/or housing which is stationary when the ingredient handling system is rotated for centrifugation and which supports the ingredient handling system.

The frame and/or housing may comprise or be fixed to a bottom configured to rest on a support surface external to such machine when the ingredient handling system is rotated about the processing axis for centrifugation, e.g. an external support surface formed by a table top, the processing axis being at an angle relative to such bottom in the range of 0° to 80°, for instance of 0° to 45°, such as of 0° to 30°, e.g. of 0° to 15°, typically of substantially 0°.

The frame and/or housing can support a motor that is connected to the ingredient handling system, for instance connected directly or via a transmission such as at least one of belts e.g. toothed belts, gears e.g. spur gears, and connecting rods. Rotation of the ingredient handling system about the processing axis during centrifugation may thus be achieved by such motor.

One or more of the beverage outlet(s) and the water inlet(s) can be associated with one or more capsule openers, such as capsule piercers.

The processing cavity may have a plurality of beverage outlets peripherally arranged at the processing cavity about the central processing axis.

Each peripherally arranged beverage outlet can be in fluid communication with the beverage passage that extends from the communicating outlet towards the processing axis.

A plurality or all of the beverage outlets can be in fluid communication with the common beverage passage in a funnel-like configuration.

A plurality or all of the beverage outlets may be in fluid communication with a corresponding plurality of beverage conduits that merge together at the central processing axis, for instance to extend along the central processing axis.

The water inlet may be located at the processing cavity on or adjacent to the processing axis.

The valve has a valve frame and, relatively movable thereto, a valve part extends that substantially annularly around the processing axis and/or substantially radially, e.g. diametrally, relative to the processing axis. The valve part controls the beverage flow and/or beverage pressure along the beverage passage.

Typically the valve frame is stationary relative to the machine frame and/or housing and/or stationary relative to the beverage passage.

Such a valve configuration may be used to reduce vibrations in the machine.

The valve along the beverage passage may thus be used control the flow and/or pressure in the ingredient, especially when supplied within a capsule.

The valve along the beverage passage can be used to control the quantity of water in the processing cavity, especially in the capsule when the ingredient is supplied with a capsule.

For example, the valve part displaces a gate to increase and reduce, such as allow and interrupt, the beverage flow and/or beverage pressure at a valve portion of the passage.

Valve portion can have a section that may be sealed off by the gate.

Typically, the beverage passage may extend along the processing axis.

The water inlet may be fluidically connected via an upstream water conduit to a water source e.g. to a water tank or a water distribution network.

The water conduit may extend at least in part along the processing axis, e.g. concentrically or adjacently therealong.

The beverage passage and a or the above water conduit leading to the above at least one water inlet may extend adjacently one to another or extend one within the other e.g. concentrically. The beverage passage may surround the water conduit or vice versa.

Typically the water conduit can be associated with at least one of: a water source e.g. a water tank or connection to a network; a water water thermal conditioner, e.g. a heater a and/or cooler, and optionally, the below mentioned beverage conditioner by being fixed thereto or integral therewith; a water driver e.g. a pump; and a sensor for sensing a characteristic of the water e.g. a flow sensor and/or a temperature sensor and/or a pressure sensor.

For instance, the valve part is configured to rotate about the processing axis during centrifugation, the valve part being e.g. angularly fixed to the rotatable ingredient handling system about the processing axis.

The valve part may be movable radially relative to the processing axis to control the beverage flow and/or beverage pressure.

The valve part can be movable axially relative to the processing axis to control the beverage flow and/or beverage pressure.

The valve part may be connected to at least one return spring, such as a helicoidal spring, to move the valve part into a spring-release position. For instance, the valve part is connected to a first spring and to a second spring that move the valve part at different control phases. For example, the first spring and the second spring move the valve part when the ingredient handling system is rotated at a first rotational speed and at a second speed, respectively, the first rotational speed being different to the second rotational speed.

The valve part can be actuated by an inertia body that has a centre of inertia that is off-set relative to the processing axis to radially move by rotation the valve part towards a closed or opened position.

The inertia body with the centre of inertia may form a first inertia body with a first centre of inertia, the valve part being actuated by a second inertia body that has a second centre of inertia that is off-set relative to the processing axis to radially move the valve part by rotation towards a closed or opened position, e.g. in opposition to a movement by the first inertia body. The first inertia body and the second inertia body may move radially the valve part when the ingredient handling system is rotated at a first rotational speed and at a second speed, respectively, the first rotational speed being different to the second rotational speed.

The first inertia body can be connected to a first pre-constrained return spring and the second inertia body can be connected to a second pre-constrained return spring, e.g. by a connecting element, the first and second inertia bodies moving radially to further constrain the first and second return springs, respectively, when the ingredient handling system is rotated at a first and a second rotational speed, respectively, the first rotational speed being different to the second rotational speed.

The valve part can be actuated by an electro-actuator, such as by a solenoid, to move the valve part, e.g. a magnetic valve part, towards a closed or opened position, such as to move the valve part axially relative to the processing axis.

Such an advanced valve configuration may be used to provide a non-linear control of beverage flow and/or beverage pressure by the valve.

Such configuration permits to obtain tailored flow and/or pressure profiles.

For example, the valve may be completely open at low rotational speed, e.g. to easily drain beverage from the cavity, e.g. from the capsule, and/or extract coffee at substantially no therein pressure (above ambient pressure) and/or maximal flow. At high speed, the valve may be used to pressurize the cavity, e.g. capsule, and/or reduce the beverage flow out thereof. At very high speed, the flow maybe maximised and/or the pressure minimised to empty the cavity, e.g. capsule, of beverage for instance before disposal of the used ingredient.

By providing tailored flow and/or pressure profiles, the machine may be able to carry out different beverage preparation recipes, e.g. for extracting different kinds of roast and ground coffees and/or blends thereof.

The valve may extend diametrally and/or annularly relative to the processing axis. For instance, the valve extends substantially along a direction and/or plan that is substantially orthogonal to the processing axis and/or having a centre of gravity that is located substantially on or at the processing axis. For example the valve has a gravity axis that is substantially colinear with the processing axis.

The machine may include a beverage conditioner delimiting a conditioning cavity, e.g. between two surfaces that are movable relatively to one another e.g. rotatably movable, the conditioning cavity being fluidically connected with the beverage passage. The conditioning cavity can be configured to refine the beverage supplied from the beverage outlet via the beverage passage.

The conditioning cavity may include at least one surface, such as an inner surface, that is driven with the ingredient handling when system rotated for centrifugation. Such at least one surface is for example driven in rotation about the processing axis.

For instance, when the beverage supplied from the outlet includes gas (e.g. air), the beverage a conditioner may be configured to refine the mixing, e.g. dispersion, of the gas in the beverage, e.g. to improve the quality of a beverage-gas emulsification. When the beverage is coffee, then the conditioner may be configured to refine the coffee crema.

Typically the beverage conditioner leads to a downstream beverage dispenser configured to dispense the beverage to a user receptacle, e.g. a cup or mug.

The valve may be fluidically located between the beverage outlet and the conditioning cavity.

The conditioning cavity can be at least partly off-set relative to the processing cavity along the processing axis, optionally off-set by a distance of at least 25% of a total axial length of the conditioning cavity, such as at least 50% of the axial length, for instance at least 75% of the axial length. For example, the conditioning cavity is entirely off-set relative to the processing cavity, e.g. relative to the rotatable ingredient handling system, along the processing axis.

The beverage conditioner may include an overflow cavity that is in fluid communication with the conditioning cavity for storing beverage prior to its conditioning when the conditioning cavity is full with beverage that is being conditioned.

The overflow cavity may extend from the conditioning cavity towards the processing axis to a distance therefrom that is less than 75%, such as less than 60%, for instance less than 40%, e.g. less than 25%, of a distance spacing the conditioning cavity from the processing axis.

The beverage exit passage can be connected to the conditioning cavity at a level corresponding to a top of the overflow cavity or thereabove.

The processing cavity may about extend the processing axis up to a maximum processing distance from the processing axis. The conditioning cavity may extend about the processing axis up to a maximum conditioning distance from the processing axis. The conditioning distance may be equal to or smaller than the processing distance. For instance, the conditioning distance is in the range of 50 to 100% of the processing distance, such as at least 75%, e.g. at least 85%, for example at least 90% of the processing distance.

The conditioning cavity can be delimited by an outermost substantially cylindrical surface and/or an inner substantially cylindrical surface.

For instance, such outermost and such inner substantially cylindrical surfaces are combined to rotate one surface relative to the other surface about the processing axis during centrifugation.

Such one surface, e.g. the outermost surface, may be stationary relative to the machine frame and/or housing and such other surface, e.g. the inner surface, may be rotatable with the rotatable ingredient handling system during centrifugation. For instance, such other surface is angularly fixed to the ingredient handling system during centrifugation.

The outermost and inner substantially cylindrical surfaces can be sufficiently close one to the other to generate a sheering effect in the beverage contained in the conditioning cavity, such as a couette flow, Taylor flow, Vortex flow or turbulent flow.

The outermost and inner surfaces can be spaced apart by a distance of less than 5 mm, such as less than 3 mm, e.g. less than 2 mm.

The invention also relates to a system comprising a machine as described above and such capsule containing the flavouring ingredient.

Another aspect of the invention concerns a method of preparing in above the described machine the abovementioned beverage from the flavouring ingredient supplied within the abovementioned capsule into the machine. The method comprises the steps of:
holding and rotating the capsule with the ingredient handling system;
feeding the water via the water inlet into the capsule in the processing cavity and centrifuging the ingredient with the water and forming the beverage;
releasing the beverage from the capsule via the beverage passage; and
controlling the flow and/or the pressure from the capsule of the beverage along the beverage passage by the valve having the valve part that extends substantially annularly around the processing axis and/or substantially radially relative to the processing axis.

A further aspect of the invention relates to the use of a capsule as the abovementioned capsule for: a machine as described above; implementing the system as described above; or carrying out the method as described above.

The capsule may be used to perform the abovementioned steps.

### BRIEF DESCRIPTION OF THE DRAWINGS

The invention will now be described with reference to the schematic drawings, wherein:

FIG. 1 is a cross-sectional side view of part of a machine that has a centrifugal processing cavity and a valve according to the invention;

FIG. 2 is a partly cut-away perspective view of the centrifugal processing cavity and the valve shown in FIG. 1;

FIG. 3 is a perspective view of part of the machine shown in FIG. 1;

FIG. 4 is a perspective view a centrifugal valve suitable to be used as the above mentioned valve of the machine shown in FIG. 1;

FIG. 5 is a perspective view of the valve, shown in FIG. 4, partly cut away, in a resting open position when the valve is stationary the about processing axis;

FIG. 6 is a perspective view of the valve, shown in FIG. 4, partly cut away, in a closed position when the valve is rotated about the processing axis at a first speed;

FIG. 7 is a perspective view of the valve, shown in FIG. 4, partly cut away, in an open position when the valve is rotated about the processing axis at a second speed;

FIG. 8 is a perspective view of an electro-valve, partly cut way, suitable to be implemented in the machine shown in FIG. 1;

FIG. 9 is a cross-section of the valve shown in FIG. 8, in an open position; and

FIG. 10 is a cross-section of the valve shown in FIG. 8, in an closed position.

### DETAILED DESCRIPTION

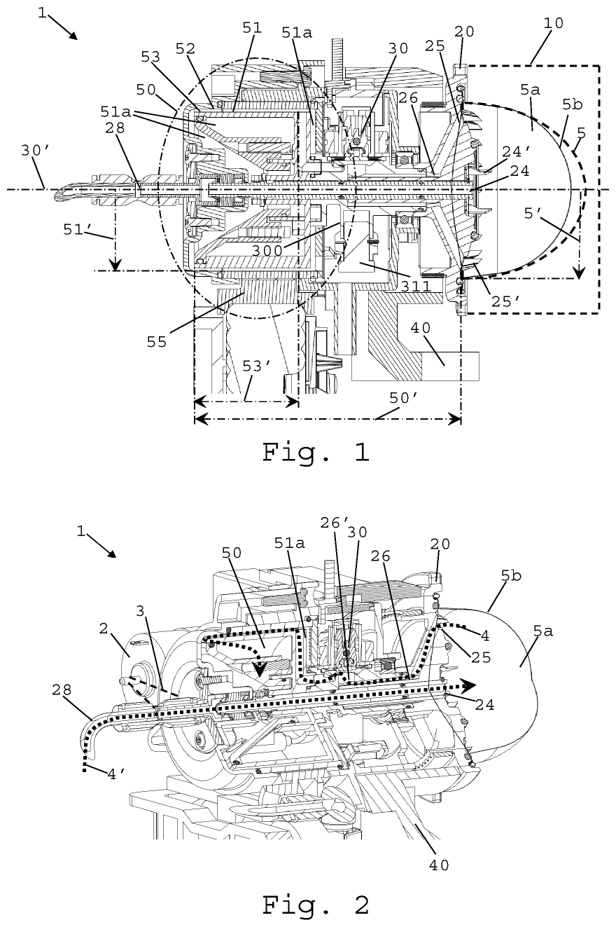

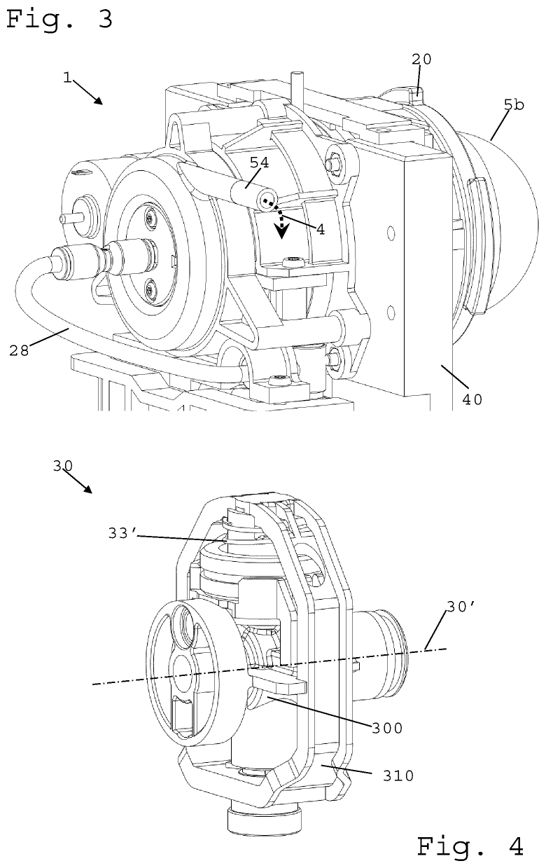

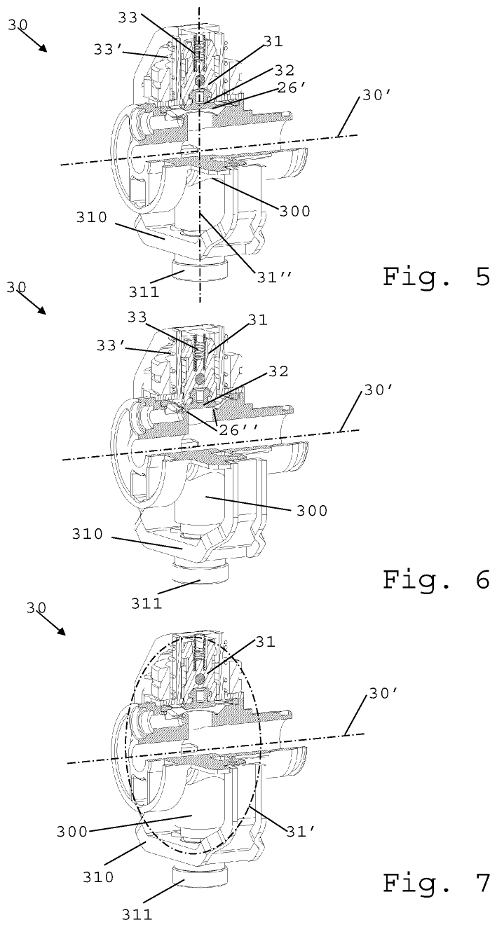

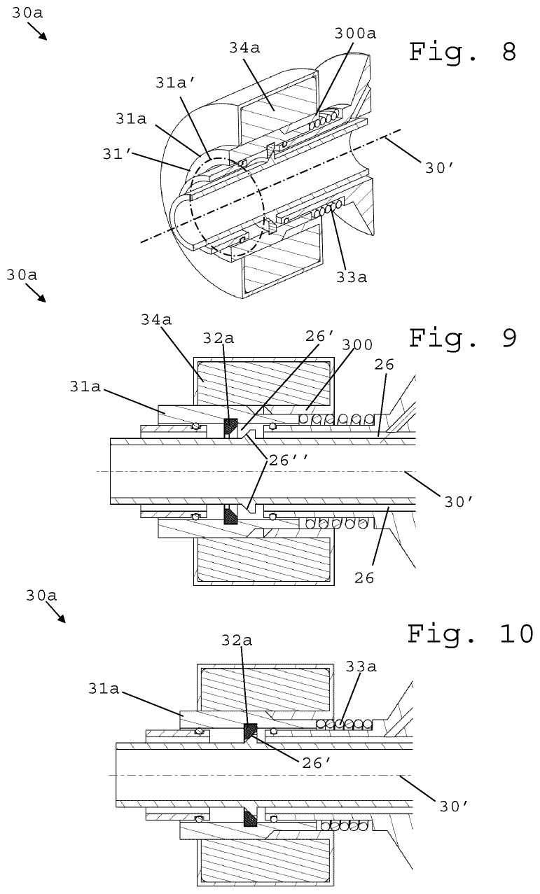

FIGS. 1 to 3 illustrate an exemplary embodiment of a machine 1 in accordance with the invention.

Machine 1 is configured for preparing a beverage 4 from a flavouring ingredient 5a in a processing cavity 5, such as a cavity 5 for holding ingredient 5a supplied within a capsule 5b, by mixing ingredient 5a with water 4′ and centrifugally driving such ingredient 5a and water 4′ about a processing axis 30′ to form beverage 4.

Machine 1 includes a rotatable ingredient handling system 10,20 for holding and rotating flavouring ingredient 5a and water during centrifugation about processing axis 30′. Ingredient handling system 10,20 has at least one beverage outlet 25 and at least one water inlet 24 for supplying water 4′ to ingredient 5a.

System 10,20 may include a first ingredient handler 10 and a second ingredient handler 20 that are movable one relative to the other from:
an ingredient transfer configuration for receiving ingredient 5a by first and second capsule handlers 10,20 and/or releasing ingredient 5a from first and second ingredient handlers 10,20; to
an ingredient processing configuration for centrifuging ingredient 5a and water 4′ by rotation about processing axis 30′; and
vice versa.

Machine 1 has a beverage passage 26, e.g. a beverage conduit, in fluid communication with beverage outlet 25. Such passage 26 can be configured to guide beverage 4 from outlet 25 towards a beverage dispensing outlet 54.

Machine 1 includes a valve 30,30a associated with beverage passage such as a 26, centrifugal and/or electric valve 30, 30a, for controlling the flow and/or the pressure of beverage 4 along beverage passage 26. Valve 30,30a is configured to increase and reduce, such as allow and interrupt, the beverage flow and/or beverage pressure at a valve portion 26 of passage 26.

Machine 1 has a machine frame and/or housing 40 which is stationary when ingredient handling system 10,20 is rotated for centrifugation and which supports ingredient handling system 10,20.

Frame and/or housing 40 may include or be fixed to a bottom configured to rest on a support surface external to such machine 1 when ingredient handling system 10, 20 is rotated about processing axis 30′ for centrifugation. Such external support surface can be formed by a table top. Processing axis 30′ may be at an angle relative to such bottom in the range of 0° to 80°, for instance of 0° to 45°, such as of 0° to 30°, e.g. of 0° to 15°, typically of substantially 0°.

Frame and/or housing 40 can support a motor 2 that is connected to ingredient handling system 10,20, for instance connected directly or via a transmission 3 such as at least one of belts e.g. toothed belts, gears e.g. spur gears, and connecting rods.

One or more of beverage outlet(s) 25 and water inlet(s) 24 may be associated with one or more capsule openers 24′, 25′, such as capsule piercers 24′, 25′.

Processing cavity 5 can have a plurality of beverage outlets 25 peripherally arranged at processing cavity 5 about central processing axis 30′.

Processing cavity 5 may have water inlet 24 located at processing cavity 5 on or adjacent to axis 30′.

Valve 30, 30a has a valve frame 300,300a and, relatively movable thereto, a valve part 31,310,311,31a that extends substantially annularly 31′, 31a′ around processing axis 30′ and/or substantially radially 31″, e.g. diametrally, relative to processing axis 30′, and that controls the beverage flow and/or beverage pressure along beverage passage 26.

Valve part 31,310,311,31a may displace a gate 32,32a to increase and reduce, such as allow and interrupt, beverage 4 flow at a valve portion 26′ of passage 26. Valve portion 26′ may have a section 26″ that can be sealed off by gate 32, 32a.

Beverage passage 26 may for instance extend along processing axis 30′.

Beverage passage 26 and a water conduit 28 leading to at least one water inlet 24 can extend adjacently one to another or can extend one within the other, e.g. concentrically. Beverage passage 26 may surround water conduit 28 or vice versa.

For example, water conduit 28 is associated with at least one of a water source, a thermal conditioner 55, a water driver, and a sensor for sensing a characteristic of water 4′.

Valve part 31,310,311,31a may be configured to rotate about processing axis 30′ during centrifugation. For example, valve part 31,310,311,31a is angularly fixed to rotatable ingredient handling system 10,20 about processing axis 30′.

Valve part 31,310,311 can move radially relative to processing axis 30′ to control the beverage flow and/or beverage pressure.

Valve part 31a may move axially relative to processing axis 30′ to control the beverage flow and/or beverage pressure.

Valve part 31,310,311,31a may be connected to at least one return spring 33, 33′, 33a, such as a helicoidal spring, to move valve part 31,310,311,31a into a spring-release position. Valve part 31,310,311 can be connected to a first spring 33 and to a second spring 33′ that move valve part 31, 310,311 at different control phases. First spring 33 and second spring 33′ may move valve part 31,310, 311 when ingredient handling system 10,20 is rotated at a first rotational speed and at a second speed, respectively, the first rotational speed being different to the second rotational speed.

Valve part 31,310,311 may have an inertia body that has a centre of inertia that is off-set relative to processing axis 30′ to radially move by rotation valve part 31,310,311 towards a closed or opened position.

This inertia body with the centre of inertia can form a first inertia body 31 with a first centre of inertia, the valve part 31,310,311 being actuated by a second inertia body 310, 311 that has a second centre of inertia that is off-set relative to processing axis 30′ to radially move valve part 31,310,311 by rotation towards a closed or opened position, e.g. in opposition to a movement by first inertia body 31. First inertia body 31 and second inertia body 310, 311 may move radially valve part 31,310,311 when ingredient handling system 10,20 is rotated at a first rotational speed and at a second speed, respectively, the first rotational speed being different to the second rotational speed.

First inertia body 31 may be connected to a first pre-constrained return spring 33 and second inertia body 310, 311 may be connected to a second pre-constrained return spring 33′, e.g. by a connecting element 310, first and second inertia bodies 31; 310, 311 moving radially to further constrain first and second return springs 33,33′, respectively, when ingredient handling system 10,20 is rotated at a first and a second rotational speed, respectively, the first rotational speed being different to the second rotational speed.

Valve part 31a can be actuated by an electro-actuator, such as by a solenoid 34a, to move valve part 31a, e.g. a magnetic valve part, towards a closed or opened position, such as to move valve part 31a axially relative to processing axis 30′.

Valve 30,30a may extend diametrally and/or annularly relative to processing axis 30′. Valve 30, 30a can extend substantially along a direction and/or plan that is substantially orthogonal to processing axis 30′. Valve 30,30a can have a centre of gravity that is located substantially on or at processing axis 30′.

Valve 30,30a may have a gravity axis that is substantially colinear with processing axis 30′.

Machine 1 may include a beverage conditioner 50 delimiting a conditioning cavity 51, e.g. between two surfaces 52,53 that are movable relatively to one another e.g. rotatably movable. Conditioning cavity 51 may be fluidically connected with beverage passage 26. Conditioning cavity 51 can be configured to refine beverage 4 supplied from beverage outlet 25 via beverage passage 26.

Conditioner 50 may be connected and in (direct) thermal communication with a or the abovementioned thermal conditioner 55 to thermally condition cavity 51.

Valve 30,30a may be fluidically located between beverage outlet 25 and conditioning cavity 51.

Conditioning cavity 51 can be at least partly off-set relative to processing cavity 5 along processing axis 30′, optionally off-set by a distance 50′ of at least 25% of a total axial length 53′ of conditioning cavity 51, such as at least 50% of the axial length, for instance at least 75% of the axial length, e.g. conditioning cavity 51 being entirely off-set relative to processing cavity 5 along processing axis 30′.

Processing cavity 5 may extend about processing axis up to a maximum processing distance 5′ from 30′ processing axis 30′. Conditioning cavity 51 can extend about processing axis 30′ up to a maximum conditioning distance 51′ from processing axis 30′. Conditioning distance 51′ can be equal to or smaller than processing distance 5′. For example conditioning distance 51′ is in the range of 50 to 100% of processing distance 5′, such as at least 75%, e.g. at least 85%, for example at least 90% of processing distance 5′.

Conditioning cavity 51 can be entirely off-set relative to processing cavity 5 along processing axis 30′. For example, beverage conditioner 50 is entirely off-set relative to rotatable ingredient handling system 10,20.

Beverage conditioner 50 may an overflow include cavity 51a is fluid that in communication with conditioning cavity 51 for storing beverage 4 prior to its conditioning when conditioning cavity 51 is full with beverage 4 that is being conditioned.

Overflow cavity 51a can extend from conditioning cavity 51 towards processing axis 30′ to a distance therefrom that is less than 75%, such as less than 60%, for instance less than 40%, e.g. less than 25%, of a distance spacing conditioning cavity 51 from processing axis 30′.

Beverage exit passage 54 may be connected to conditioning cavity 51 at a level corresponding to a top of overflow cavity 51a or thereabove.

Conditioning cavity 51 may be delimited by an outermost substantially cylindrical surface 52 and/or an inner substantially cylindrical surface 53.

For example, machine 1 includes such outermost and inner substantially cylindrical surfaces 52,53 that are rotatable one surface 53 relative to the other surface 52 about processing axis 30′ during centrifugation.

This one surface 52, such as outermost surface 52, may be stationary relative to machine frame and/or housing 40 and this other surface 53, such as inner surface 53, may be e.g. angularly fixed to the ingredient handling system 10,20 during centrifugation.

Outermost and substantially cylindrical inner surfaces 52,53 can be sufficiently close one to the other to generate a sheering effect in beverage 4 contained in conditioning cavity 51, such as a couette flow, Taylor flow, Vortex flow or turbulent flow.

Outermost and inner surfaces 52,53 may be spaced apart by a distance of less than 5 mm, such as less than 3 mm, e.g. less than 2 mm.

1. A machine for preparing a beverage from a flavouring ingredient in a processing cavity by mixing said ingredient with water and centrifugally driving such ingredient and said water about a processing axis to form said beverage, such machine comprising:
a rotatable ingredient handling system for holding and rotating said flavouring ingredient and water during centrifugation about the processing axis, the ingredient handling system having at least one beverage outlet and at least one water inlet for supplying said water to said ingredient:
an ingredient transfer configuration for receiving said ingredient by the first and second capsule handlers and/or releasing said ingredient from the first and second ingredient handlers; to
an ingredient processing configuration for centrifuging said ingredient and water by rotation about the processing axis; and
a beverage passage, e.g. a beverage conduit, in fluid communication with the beverage outlet, the passage being configured to guide said beverage from the outlet towards a beverage dispensing outlet;
a valve associated with the beverage passage, such as a centrifugal and/or electric valve, for controlling the flow and/or the pressure of said beverage along the beverage passage, the valve being configured to increase and reduce; and
a machine frame and/or housing which is stationary when the ingredient handling system is rotated for centrifugation and which supports the ingredient handling system,
the valve has a valve frame and, relatively movable thereto, a valve part that extends substantially annularly around the processing axis and/or substantially radially relative to the processing axis, and that controls the beverage flow and/or beverage pressure along the beverage passage.

2. The machine of claim 1, wherein the valve part is configured to rotate about the processing axis during centrifugation.

3. The machine of claim 1, wherein the valve part is movable radially relative to the processing axis to control said beverage flow and/or beverage pressure.

4. The machine of claim 1, wherein the valve part is movable axially relative to the processing axis to control said beverage flow and/or beverage pressure.

5. The machine of claim 1, wherein the valve part is connected to at least one return spring.

6. The machine of claim 1, wherein the valve part has an inertia body that has a centre of inertia that is off-set relative to the processing axis to radially move by rotation the valve part towards a closed or opened position.

7. The machine of claim 6, wherein said inertia body with said centre of inertia forms a first inertia body with a first centre of inertia, the valve part being actuated by a second inertia body that has a second centre of inertia that is off-set relative to the processing axis to radially move the valve part by rotation towards a closed or opened position.

8. The machine of claim 7, wherein the first inertia body is connected to a first pre-constrained return spring and said second inertia body is connected to a second pre-constrained return spring.

9. The machine of claim 1, wherein the valve part is actuated by an electro-actuator, such as by a solenoid, to move the valve part, e.g. a magnetic valve part, towards a closed or opened position.

10. The machine of claim 1, wherein the valve extends diametrally and/or annularly relative to the processing axis.

11. The machine of claim 1, which comprises a beverage conditioner delimiting a conditioning cavity, the conditioning cavity being fluidically connected with the beverage passage, the conditioning cavity being configured to refine said beverage supplied from the beverage outlet via the beverage passage, the valve being for instance fluidically located between the beverage outlet and the conditioning cavity.

12. The machine of claim 11, wherein the conditioning cavity is at least partly off-set relative to the processing cavity along the processing axis.

13. (canceled)

14. A method of preparing in a machine for preparing a beverage from a flavouring ingredient in a processing cavity by mixing said ingredient with water and centrifugally driving such ingredient and said water about a processing axis to form said beverage, such machine comprising:
a rotatable ingredient handling system for holding and rotating said flavouring ingredient and water during centrifugation about the processing axis, the ingredient handling system having at least one beverage outlet and at least one water inlet for supplying said water to said ingredient:
an ingredient transfer configuration for receiving said ingredient by the first and second capsule handlers and/or releasing said ingredient from the first and second ingredient handlers; to
an ingredient processing configuration for centrifuging said ingredient and water by rotation about the processing axis; and
a beverage passage, e.g. a beverage conduit, in fluid communication with the beverage outlet, the passage being configured to guide said beverage from the outlet towards a beverage dispensing outlet;
a valve associated with the beverage passage, such as a centrifugal and/or electric valve, for controlling the flow and/or the pressure of said beverage along the beverage passage, the valve being configured to increase and reduce; and
a machine frame and/or housing which is stationary when the ingredient handling system is rotated for centrifugation and which supports the ingredient handling system,
the valve has a valve frame and, relatively movable thereto, a valve part that extends substantially annularly around the processing axis and/or substantially radially relative to the processing axis, and that controls the beverage flow and/or beverage pressure along the beverage passage, a beverage from said flavouring ingredient supplied within a capsule into the machine, the method comprising:
holding and rotating the capsule with said handling system;
feeding said water via the water inlet into said capsule in the processing cavity and centrifuging the flavouring ingredient with the water and forming said beverage;
releasing the beverage from said capsule via the beverage passage; and
controlling the flow and/or the pressure from said capsule of said beverage along the beverage passage by the valve having the valve part that extends substantially annularly around the processing axis and/or substantially radially relative to the processing axis.

15. (canceled)
